(19) United States
(12) Patent Application Publication
(10) Pub. No.: US 2016/0059758 A1
(43) Pub. Date: Mar. 3, 2016

(54) SEAT LEVELER FOR FRAGILE CARGO

(71) Applicant: Ford Global Technologies, LLC, Dearborn, MI (US)

(72) Inventors: Annette Lynn Huebner, White Lake, MI (US); Susan Drobyshewski, Plymouth, MI (US); Kristin Ann Hellman, Walled Lake, MI (US); Johnathan Andrew Line, Northville, MI (US)

(73) Assignee: Ford Global Technologies, LLC

(21) Appl. No.: 14/469,148

(22) Filed: Aug. 26, 2014

(51) Int. Cl. B60N 3/00; B60N 2/44; B60N 2/02

(52) U.S. Cl. CPC B60N 3/00; B60N 2/02; B60N 2/442

(57) ABSTRACT

A seat leveler for a vehicle seating assembly includes a body having a cavity filled with a shape-conforming medium. A support surface is disposed above the body and includes a non-slip surface material and a raised peripheral rim. A seat engaging surface is arranged at an angle below the support surface. The seat engaging surface includes a flexible material configured to flex with the shape-conforming medium. The seat engaging surface is operably coupled to a first portion of an underside of the support surface and a second portion of the underside of the support surface is exposed and in contact with a vehicle seat. A height-adjustable rear wall is disposed between the support surface and the seat engaging surface.

### FIELD OF THE DISCLOSURE

The present disclosure generally relates to a vehicle seating assembly, and more particularly to a vehicle seating assembly with a seat leveler for fragile cargo.

### BACKGROUND OF THE DISCLOSURE

In an effort to increase the comfortability of seating assemblies, seats and seatbacks are frequently angled inside a vehicle, thereby creating an uneven surface. This uneven surface is not desirable when transporting liquids or easily spillable materials.

### SUMMARY OF THE DISCLOSURE

According to one aspect of the present disclosure, a seat leveler for a vehicle seating assembly includes a body having a cavity filled with a shape-conforming medium. A support surface is disposed above the body and includes a non-slip surface material and a raised peripheral rim. A seat engaging surface is arranged at an angle below the support surface. The seat engaging surface includes a flexible material configured to flex with the shape-conforming medium. The seat engaging surface is operably coupled to a first portion of an underside of the support surface and a second portion of the underside of the support surface is exposed and in contact with a vehicle seat. A height-adjustable rear wall is disposed between the support surface and the seat engaging surface.

According to another aspect of the present disclosure, a seat leveler for a vehicle seating assembly includes a body having a cavity filled with a shape-conforming medium. A support surface is disposed above the body and includes a non-slip surface material. A seat engaging surface is arranged at an angle below the support surface. The seat engaging surface includes a flexible material configured to flex with the shape-conforming medium. A rear wall is disposed between the support surface and the seat engaging surface.

According to yet another aspect of the present disclosure, a vehicle seating assembly includes a seat and a seatback coupled with the seat. A spindle is disposed in one of the seat and seatback. A seat leveler is disposed on the spindle and is operable between a deployed position, wherein a connecting end of the seat leveler is extended horizontally and removably coupled with the other of the seat and seatback, and a stored position, wherein most of the seat leveler is wrapped around the spindle.

According to still another aspect of the present disclosure, a vehicle seating assembly includes a seat and a seatback. A surface of the seat includes a leveling device configured to rotate a rearward portion of the seat to a substantially level position. The leveling device includes one of a cam system and a fluid pump, wherein either the cam system or the fluid pump forces the rearward portion of the leveling device to a raised and level position. Cargo that can be spilled and cause damage to the seat and or seatback can then be supported on the leveling device with minimal likelihood of spillage.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a front perspective view of one embodiment of a vehicle seating assembly supporting a container in a non-level position;

FIG. 2 is a front perspective view of the container of FIG. 1 on a leveling device positioned on the vehicle seating assembly;

FIG. 3 is a top plan view of one embodiment of a leveler device for use on a vehicle seating assembly;

FIG. 4 is a side elevational view of the seat pan of FIG. 3;

FIG. 5 is a front elevational view of the seat pan of FIG. 3;

FIG. 6 is a rear elevational view of the seat pan of FIG. 3;

FIG. 7 is a front perspective view of a vehicle seating assembly of the present disclosure, having another embodiment of a leveler device;

FIG. 8 is a front perspective view of a leveler device spindle having a flexible sheet;

FIG. 9 is a front perspective view of the leveler device of FIG. 7 prior to the flexible sheet being deployed;

FIG. 10 is a front perspective view of the vehicle seat of FIG. 9 with the flexible sheet in a deployed position;

FIG. 11 is a front perspective view of the vehicle seat of FIG. 9 with a container disposed on the flexible sheet;

FIG. 12 is a front perspective view of another embodiment of a leveling device of a vehicle seat of the present disclosure;

FIG. 13 is a front perspective view of the vehicle seat of FIG. 12 with a leveling pad of the leveling device in a stowed position;

FIG. 14 is a front perspective view of the vehicle seat of FIG. 12 with a container disposed on the leveling pad with the leveling pad in a deployed and level position;

FIG. 15 is a front perspective view of another embodiment of a leveler device for a vehicle seat of the present disclosure that includes a cam system;

FIG. 16 is a front perspective view of the vehicle seat of FIG. 15 with the cam system in a deployed position; and

FIG. 17 is a front perspective view of the vehicle seat of FIG. 15 with a container disposed on the cam system.

### DETAILED DESCRIPTION OF THE EMBODIMENTS

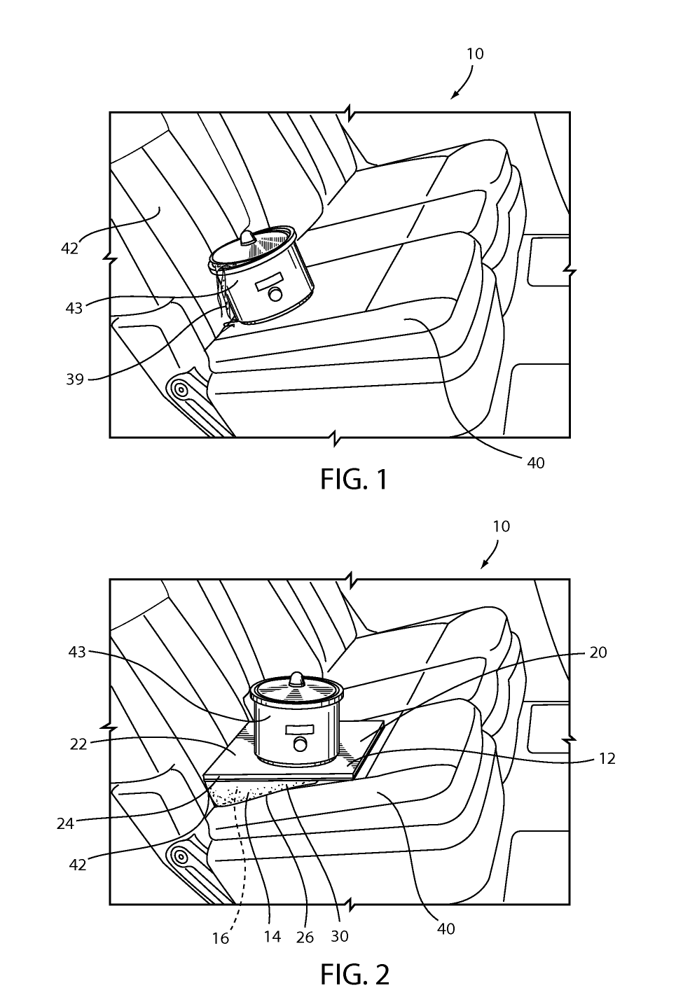

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

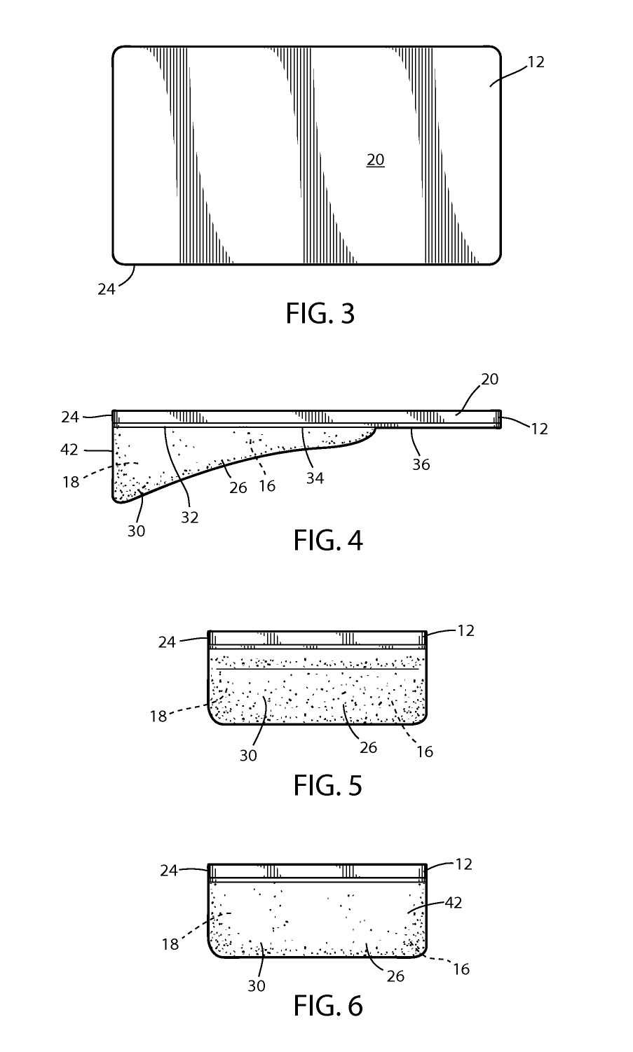

Referring to FIGS. 1-6, reference numeral 10 generally designates a vehicle seating assembly 10 having a seat leveler 12 that includes a body 14 having a cavity 16 filled with a shape-conforming medium 18. A support surface 20 is disposed above the body 14 and includes a non-slip surface material 22 and a raised peripheral rim 24. A seat engaging surface 26 is arranged at an angle below the support surface 20. The seat engaging surface 26 includes a flexible material 30 configured to flex with the shape-conforming medium 18. The seat engaging surface 26 is operably coupled to a first portion 32 of an underside 34 of the support surface 20 and a second portion 36 of the underside 34 of the support surface 20 is exposed and in contact with a vehicle seat 40. A height-adjustable rear wall 42 is disposed between the support surface 20 and the seat engaging surface 26.

With reference again to FIGS. 1 and 2, items that include a liquid or otherwise unstable material 39 inside of a container 43 can leak or flow out of the container 43, thereby causing staining or damage to the seat 40 or a seatback 42. As illustrated in FIG. 2, a seat leveler system 12 provides a manner of transporting this type of cargo, while minimizing the likelihood of spillage during transit.

With reference again to the embodiment illustrated in FIGS. 2-6, the seat leveler 12 includes a multitude of microbeads that define the shape-conforming medium 18. It is contemplated that the shape-confirming medium 18 could also include a gel, silica, or other shape-conforming material. The non-slip surface material 22 on the support surface 20 helps stabilize the container 43, minimizing the likelihood that the container 43 will move off the support surface 20. The non-slip material may include rubber, silicone, neoprene, etc. The seat leveler 12 includes triangularly-shaped sidewalls that are generally configured to complement the seating surface of the seat 40, thereby positioning the support surface 20 at a generally level orientation above the seat engaging surface 26. The triangularly-shaped sidewalls and the seat engaging surface 26 of the seat leveler 12 are constructed from a stretchable material that is flexible and allows some level of conformity to the seating surface. Accordingly, different seating surfaces having various sizes, shapes and angles can be used with the seat leveler 12. It is further contemplated that the non-slip surface material 22 is supported by a hard support structure 20 that is configured to support the weight of the container 43 that holds the liquid or otherwise spillable material inside the container 43. The hard support structure 20 can be constructed from plastic, wood, metal, etc. The seat leveler 12 can be a feature that is stored underneath the vehicle seat 40 or in a trunk of a vehicle, or can be withdrawn when necessary. Alternatively, the seat leveler 12 may be a deployable system, as noted below.

With reference again to FIGS. 2-6, the illustrated seat lever 12 is generally configured such that the shape-conforming medium 18 is disposed only below the first portion 32 of the underside 34 of the support surface 20. The second portion 36 of the underside 34 of the support surface 20 is exposed such that the second portion 36 rests directly against a forward portion of the vehicle seating surface. Accordingly, the body 14 with the shape-conforming medium 18 extends only to an intermediate portion of the support surface 20. Further, the height adjustable rear wall 42 is configured to be manipulated based upon the overall height difference between a front portion and rear portion of the vehicle seat 40. Stated differently, the height adjustable rear wall 42 can be lengthened or shortened based upon the angle of the seating surface. Accordingly, the support surface 20 can be positioned at a nearly perfectly level orientation to accommodate a container 43 that includes spillable goods therein. Further, the raised peripheral rim 24 along with the non-slip surface aids in maintaining the container 43 in position on the support surface 20.

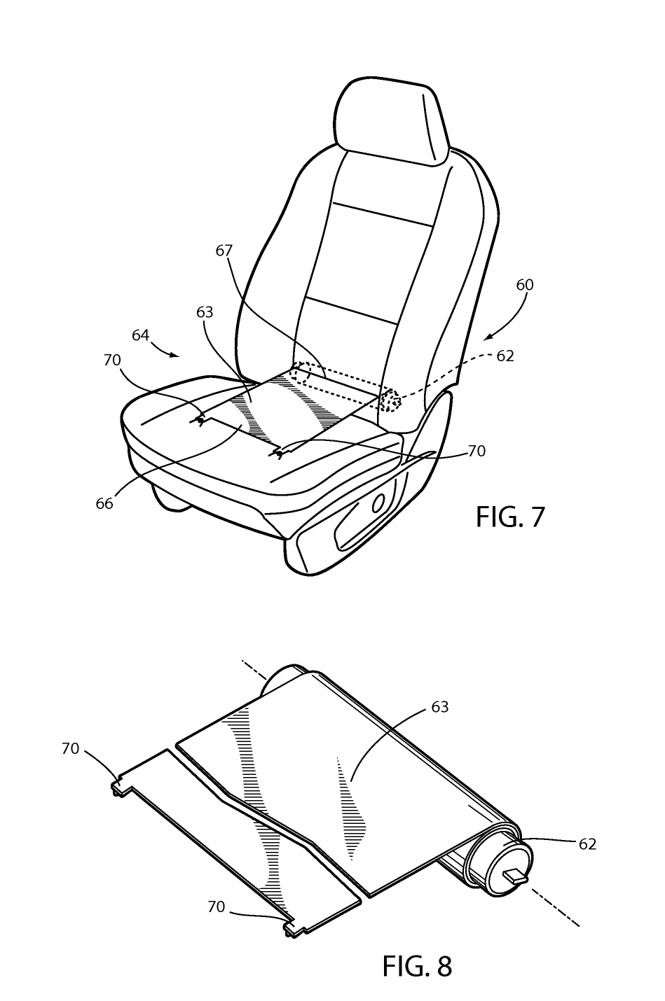

With reference to FIGS. 7 and 8, in another embodiment of the present disclosure, a seat leveler system 60 for supporting a container 43 is provided that includes a spindle 62 disposed in one of the seat 40 and the seatback 42. A flexible sheet 63 is wrapped around the spindle 62 and is operable between a deployed position 64, wherein a connecting end 66 of the seat leveler 12 is extended horizontally from a slot 67 in the seat 40 or seatback 42, and removably coupled with the other of the seat 40 and the seatback 42. The seat leveler 12 is also configured for use in a stored position 68, wherein most of the seat leveler 12 is wrapped around the spindle 62. In this instance, draw tabs 70 may be exposed from the seat 40 or the seatback 42, which aid a passenger in drawing the seat leveler 12 from the seat 40 or the seatback 42 prior to connection with the other of the seat 40 and the seatback 42. In the illustrated embodiment of FIGS. 7-9, the seat leveler 12 is withdrawn from the seatback 42 and connected with complementary tabs 72 on a seating surface 74 of the seat 40. The seat leveler 12 may be a semi-rigid material that is stored on a large spindle, may be a generally flexible material that cradles the container 43, or alternatively, may be a rigid seat leveler that is stored in the slot inside the seatback 42. In the instance where the seat leveler 12 is a rigid material, it is contemplated that the rigid seat leveler 12 would be withdrawn via rail slides that are disposed inside the seatback 42 to allow for easy movement of the seat leveler 12 between deployed and stored positions.

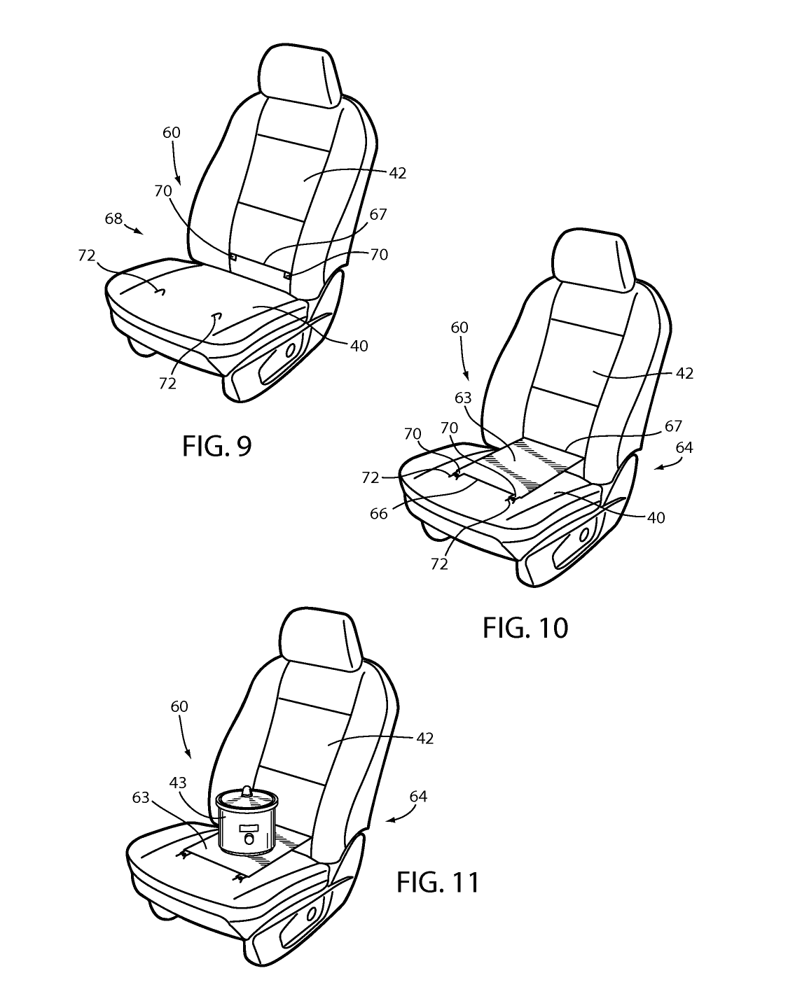

With reference now to FIGS. 9-11, the seat leveler 12 having a stored orientation on the spindle 62 is illustrated. In this instance, the spindle 62 may be spring-biased to the stored position 68 and withdrawn from the seatback 42 prior to engagement with the tabs 72 on the seat 40. Alternatively, the spindle 62 may be operably coupled with a motor that rotates the spindle 62 to the stored position 68, thereby withdrawing the seat leveler 12. In operation, with reference to FIG. 9, a user would first draw the tabs 70 outwardly from the seatback 42. Upon pulling the tabs 70, and consequently the flexible sheet 63 a sufficient distance from the seatback 42, the tabs 70 can be secured with the complementary tab 72 on the seat 40. Once the tabs 70 have been securely engaged with the complementary tabs 72, the container 43 can be positioned thereon and is ready for transportation. It will be understood that, alternatively, the flexible sheet 63 can be stored in the seat 40 and withdrawn from the seat 40 until secure engagement with complementary tabs 72 that may be disposed in the seatback 42.

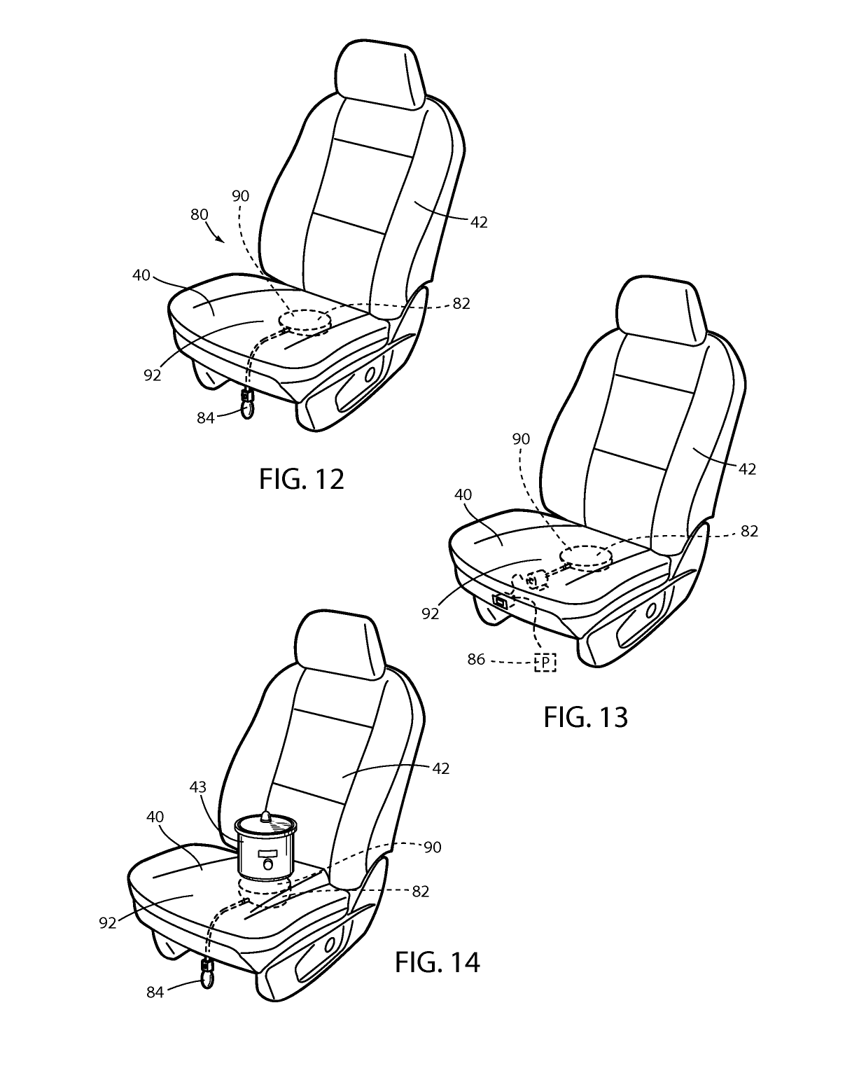

With reference now to FIGS. 12-14, in another embodiment of the present disclosure, a seat leveler system 80 includes a leveling pad 82 disposed inside the seat 40. The leveling pad 82 may be deployed via a manual pump 84 (FIG. 12) or via a motorized pump 86 (FIG. 13). In either instance, the leveling pad 82 may be filled with fluid, such that an upper surface 88 of the leveling pad 82 becomes level. In this instance, the leveling pad 82 will extend upward relative to the surrounding seating surface 92 of the seat 40. As a result, a local seating surface 90 is level as compared to a surrounding seating surface 92 of the seat 40. The container 43 may then be placed on the leveling pad 82 now that a level surface is provided on the seat 40. It will also be understood that the seat leveler system 80 could include a leveling pad 82 that is disposed under a majority of the seating surface 90 of the seat 40. Consequently, activation of the leveling pad 82 would result in a leveling of a majority of the seating surface 90. Specifically, both the local seating surface 90 and the surrounding seating surface 92 would be elevated to a level position. Accordingly, a larger item than the illustrated container 43 could be placed on the seating surface 90 and supported in a level orientation. It is also contemplated that the seat leveler system 80 may include an auto leveling system. Specifically, the seat leveler 12 may raise and lower depending on the relative orientation of the seating surface 90. For example, if the vehicle was positioned on a hill with a front of the vehicle on a downhill side, the auto leveler may limit inflation of the leveling pad 82 as the seating surface 90 is already close to a level position. Alternatively, if the vehicle is located on a substantially flat road or parking lot, the auto seat leveler will activate the leveling pad so that the local seating surface 90 is generally level.

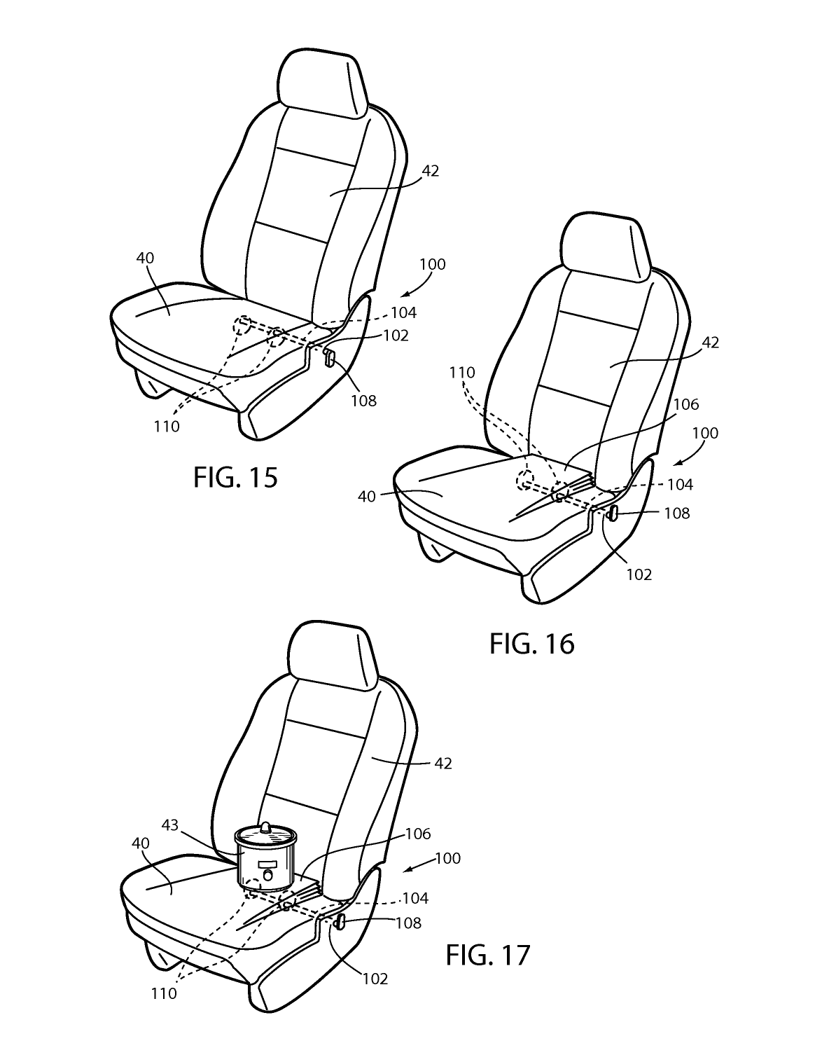

With reference to FIGS. 15-17 in the present disclosure, a seat leveler system 100 includes a cam system 102 that is rotatable about a shaft 104 to move a seating surface 106 between a raised position and a lowered position. A handle 108 is disposed on a side of the seat 40 and is operably coupled with the shaft 104. Rotation of the handle 108 results in rotation of the shaft 104 and the cam system 102. The illustrated cam system 102 includes two cams 110 configured to raise and lower the seating surface 106. As the cam system 102 rotates upward, the cam system 102 is forced to rotate the cams 110 upwardly, thereby moving the seating surface 106 to a level position. Rotation of the handle 108 in the opposite direction results in the cam system 102 rotating downward, thereby moving the seat 40 back to a passenger comfort position. When the cam system 102 is raised to the level position, a container (FIG. 17) can be placed on the cam system 102, which minimizes the likelihood of spillage or leaking from the container 43.

As illustrated in FIGS. 16 and 17, the seating surface 106 includes a pleated portion 112 that allows movement between raised and lowered positions. The seating surface 106 could also include a flexible material or excess material below the seat 40 to allow the seating surface 106 to be raised by the cam system 102. It is also contemplated that the handle 108 may be rotated to one of many intermediate positions between a fully raised and fully lowered position. Accordingly, the relative angle of a container 43 sitting on the seating surface 92 or 90 can be adjusted based on the user's preference.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A seat leveler for a vehicle seating assembly comprising:
a body including a cavity filled with a shape-conforming medium;
a support surface disposed above the body and including a non-slip surface material and a raised peripheral rim;
a seat engaging surface arranged at an angle below the support surface, the seat engaging surface including a flexible material configured to flex with the shape-conforming medium, the seat engaging surface being operably coupled to a first portion of an underside of the support surface and a second portion of the underside of the support surface is exposed and in contact with a vehicle seat; and
a height-adjustable rear wall disposed between the support surface and the seat engaging surface.

2. The seat leveler of claim 1, wherein the shape-conforming medium is a multitude of microbeads.

3. The seat leveler of claim 1, wherein the non-slip surface material includes one of rubber and silicone.

4. The seat leveler of claim 1, further comprising:
triangularly-shaped sidewalls, wherein the triangularly-shaped sidewalls and the seat engaging surface are constructed from a stretchable material.

5. The seat leveler of claim 1, wherein the seat engaging surface further includes a hard structural support disposed below the non-slip surface material.

6. A seat leveler for a vehicle seating assembly comprising:
a body including a cavity filled with a shape-conforming medium;
a support surface disposed above the body and including a non-slip surface material;
a seat engaging surface arranged at an angle below the support surface, the seat engaging surface including a flexible material configured to flex with the shape-conforming medium; and
a rear wall disposed between the support surface and the seat engaging surface.

7. The seat leveler of claim 6, wherein the rear wall is adjustable in height.

8. The seat leveler of claim 6, wherein the shape-conforming medium is a multitude of microbeads.

9. The seat leveler of claim 6, wherein the non-slip surface material includes one of rubber and silicone.

10. The seat leveler of claim 6, further comprising:
triangularly-shaped sidewalls, wherein the triangularly-shaped sidewalls and the seat engaging surface are constructed from a stretchable material.

11. The seat leveler of claim 6, wherein the seat engaging surface is operably coupled to a first portion of an underside of the support surface and a second portion of the underside of the support surface is exposed and in contact with a vehicle seat.

12. The seat leveler of claim 6, further comprising:
a raised peripheral rim.

13. The seat leveler of claim 6, wherein the seat engaging surface further includes a hard plastic structural support disposed below the non-slip surface material.

14. A vehicle seating assembly comprising:
a seat;
a seatback coupled with the seat;
a spindle disposed in one of the seat and seatback; and
a seat leveler disposed on the spindle and being operable between a deployed position wherein a connecting end of the seat leveler is extended horizontally and removably coupled with the other of the seat and seatback, and a stored position, wherein most of the seat leveler is wrapped around the spindle.

15. The vehicle seating assembly of claim 14, wherein connecting features are disposed on the other of the seat and the seatback to engage the connecting end of the seat leveler.

16. The vehicle seating assembly of claim 14, wherein the seat leveler includes tabs disposed on the connecting end configured to aid a user in unwrapping the seat leveler from the spindle.

17. The vehicle seating assembly of claim 14, wherein the spindle is spring-biased to urge the seat leveler to the stored position.

18. The vehicle seating assembly of claim 14, wherein a top side of the seat leveler includes a non-slip material.

19. The vehicle seating assembly of claim 14, wherein the seat leveler is constructed from a flexible material configured to cradle items positioned on the seat leveler.

20. The vehicle seating assembly of claim 14, wherein the seat leveler is drawn through a slot formed in one of the seat and the seatback.
